(19) United States
(12) Patent Application Publication
(10) Pub. No.: US 2010/0023927 A1
(43) Pub. Date: Jan. 28, 2010

(54) APPARATUS AND METHOD FOR MIDLET SUITE MANAGEMENT USING DRM IN A MOBILE COMMUNICATION SYSTEM

(75) Inventors: Jong-Seok Yang, Suwon-si (KR); Kum-Hyun Cho, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si, Gyeonggi-do (KR)

(21) Appl. No.: 12/494,777

(22) Filed: Jun. 30, 2009

(30) Foreign Application Priority Data
Jul. 22, 2008 (KR) 10-2008-0071391

(51) Int. Cl. G06F 9/44; G06F 9/445

(52) U.S. Cl. 717/120; 717/174

(57) ABSTRACT

An apparatus and method for MIDlet suite management using Digital Rights Management (DRM) in a mobile communication system are provided. A Java Application Descriptor (JAD) file transmission method of a transmit Mobile Station (MS) in a mobile communication system includes inserting a JAD file into an Open Mobile Alliance Digital Rights Management (OMA DRM) file, and transmitting the OMA DRM file in which the JAD file is inserted, to a receive MS.

### PRIORITY

This application claims the benefit under 35 U.S.C. §119(a) of a Korean patent application filed in the Korean Intellectual Property Office on Jul.22, 2008 and assigned Serial No. 10-2008-0071391, the entire disclosure of which is hereby incorporated by reference.

### BACKGROUND OF THE INVENTION

1. Field of the Invention

The present invention relates to an apparatus and method for generating and managing a Java ARchive (JAR) file and Java Application Descriptor (JAD) file. More particularly, the present invention relates to a MIDlet suite as an Open Mobile Alliance Digital Rights Management (OMA DRM) file, using OMA DRM that defines a DRM technology for content in a terminal of a mobile communication system.

2. Description of the Related Art

Open Mobile Alliance Digital Rights Management (OMA DRM) is a standard for defining DRM technologies for content in a terminal, and the standards of a version 1.0 (v1.0), a v2.0, and a v2.1 are currently in use. OMA DRM v1.0 and OMA DRM v2.0 define a format of each DRM file. A Mobile Information Device Profile (MIDP) is the standard for defining Application Programming Interfaces (APIs) for mobile information equipment using Java 2 Micro Edition (J2ME). A Java application program driven in a MIDP environment is referred to as a MIDlet, and a set of MIDlets is referred to as a MIDlet suite.

The MIDlet suite denotes a J2ME application program. This is an application program executable in MIDP 1.0 or MIDP 2.0. While MIDlet suites may be distributed in one of a Java Application Descriptor (JAD) file and a Java ARchive (JAR) file, they are typically only distributed in a .JAR file.

The MIDlet suite has to be installed in an apparatus intended for execution according to an item specified in a MIDP standard. In general, if a J2ME application program is installed in an apparatus, system files such as those identified in Table 1 below are generated.

TABLE 1

| | Description of example of system file of J2ME | |
|---|---|---|
| File | application program | |
| JAD | <storage name of MIDlet | Store .JAD file in format in which |
| | suite>_suite.jad | storage name of MIDlet |
| | | suite is included. |
| JAR | <storage name of MIDlet | Store .JAR file in format in which |
| | suite>_suite.jar | storage name of MIDlet |
| | | suite is included. |
| Manifest | <storage name of MIDlet | Take out MANIFEST.MF file |
| | suite>_suite.mf | within .JAR file and store in |
| | | format in which storage name |
| | | of MIDlet suite is included. |
| Settings | <storage name of MIDlet | Store permission given at time of |
| .Bin | suite>_settings.bin | API use in MIDlet suite. |
| JAD | <storage name of MIDlet | Store URL downloading .JAD file. |
| URL | suite>_jadUrl.utf | |
| JAR | <storage name of MIDlet | Store URL downloading .JAR file. |
| URL | suite>_jarUrl.utf | |

In general, J2ME application programs installed are managed by an Application Management System (AMS) or a Java Application Management System (JAM).

Information of a MIDlet suite is extracted from the “<storage name of MIDlet suite>_suite.jad” file among the aforementioned system files, and is displayed for a user.

In the case of executing the installed MIDlet suite, Java class files within the “<storage name of MIDlet suite>_suite.jar” file are executed in a Java Virtual Machine (JVM). A class name to be executed refers to the “<storage name of MIDlet suite>_suite.mf”. A call and limitation of a Java API are determined based on a permission described in the “<storage name of MIDlet suite>_settings.bin”. Data that needs to be retained while the MIDlet suite is executed is stored through a Record Management System (RMS).

The RMS stores data, intended for storage in the MIDlet suite, in a nonvolatile storage space that is referred to as a record store. The MIDlet suite uses an API within a “javax.mircoedition.rms” package among MIDP APIs.

A recent mobile communication terminal provides functions for enabling a user to use a storage space within the mobile communication terminal through a Universal Serial Bus (USB), etc. at the user's convenience. Content such as MPEG Audio Layer-3 (MP3), Joint Photographic Experts Group (JPEG), etc. is distributed in one file format and, upon execution, information having to be stored in a corresponding file is not generated. However, a J2ME application program is distributed in .JAD and .JAR and, upon installation, system files having to be generated and managed exist. If the user may access these files using an interface such as USB, the J2ME application program may not be managed normally. Thus, there is a need for a method in which a user uses a mobile communication terminal in an external memory using USB, etc. while being capable of protecting files of a J2ME application program.

Users store music, movies, etc. in an external memory apparatus and desire reproduction in several apparatuses. However, there is a limitation in which a J2ME application program is executed only in a specific apparatus in which it was downloaded and installed. A method does not exist in which a user may use information stored in an existing apparatus despite the same J2ME application program having been installed and used in a different apparatus. Thus, there is a need for a method in which a user maintains information generated in a J2ME application program while being capable of using the same J2ME application program in several apparatuses.

In general, a J2ME application program distributed is distributed in .JAD and .JAR files. Because the .JAR file may be decompiled by a user, there is a danger in which a source code of the J2ME application program may be exposed. Thus, there is a need for a method for preventing a user from decompiling a class code within a JAR file while being capable of distributing a J2ME application program.

In recent years, J2ME application programs are increasing in availability that, after a user mounts a J2ME application program for demonstration in a mobile communication terminal and tries running the J2ME application, convert the J2ME application program to a regular version. In this case, there is a problem of having to realize a purchase system of a regular version by a J2ME application program.

The .JAD file denotes information used to download and install a JAVA MIDlet in a mobile communication terminal. The .JAD file is often used at the time of installation. However, there is no definition of a definite standard for a mechanism for managing the .JAD file. Thus, after installation, the .JAD file is arbitrarily stored within a terminal or deleted, depending on the terminal.

As such, because a guideline for management of a .JAD file is not definite, it is difficult to apply a function of “super distribution” (i.e., forwarding) to a JAVA MIDlet. In addition, there are the following problems with “super distribution”.

First, a .JAD file is managed as a separate file and thus, .JAD and .JAR (representing a JAVA MIDlet) files may be forwarded together. However, this may not be convenient to a user because two files at a user side have to be managed when downloading one JAVA game or application program. Also, using a Multimedia Message Service (MMS), an electronic mail (E-mail), a Bluetooth, or an F-flash to forward may not be convenient to the user because two .JAD and .JAR files need to be forwarded.

Second, in the case of defining a new format of a combination of .JAD and .JAR files as a solution to the first problem, a new standard is required, and in each application program, an additional process for this format is required.

Third, an issue with forwarding .JAD and .JAR files is that corresponding JAVA content is copied and distributed with no authorization for use at a content provider side and thus, is difficult.

Fourth, in the case of applying DRM to a .JAR file as an alternative to the second problem, the .JAR file is managed with an extension of “.dcf”, “.dm” (OMA DRM v1.0), or “.odf” (OMA DRM v2.0 or more). Hence, there is a problem in that it is difficult for a user to consider that a corresponding DRM file is a .JAR file based on this extension.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for MIDlet suite management using Digital Rights Management (DRM) in a mobile communication system.

Another aspect of the present invention is to provide an apparatus and method for protecting and managing a MIDlet suite by DRM.

Yet another aspect of the present invention is to provide an apparatus and method for protecting files of a MIDlet suite from a malicious loss or damage while enabling execution in various apparatuses (i.e., a mobile communication terminal, an external memory, etc.).

A further aspect of the present invention is to provide an apparatus and method for enabling management of a Java Application Descriptor (JAD) file and addressing a problem of a “super distribution”, thus providing a function of forwarding a JAVA MIDlet in a mobile communication system that is convenient to a user.

Still another aspect of the present invention is to provide an apparatus and method for, by including JAD and Java ARchive (JAR) files in an Open Mobile Alliance Digital Rights Management (OMA DRM) file and transmitting, enabling transmission of all contents by only OMA DRM file transmission in a mobile communication system.

Another aspect of the present invention is to provide an apparatus and method for, by allowing a user downloading a JAVA game or application program to which DRM is applied using a DRM function to go through a separate right purchase procedure, providing a benefit to a content provider in a mobile communication system.

The above aspects are addressed by providing an apparatus and method for MIDlet suite management using DRM in a mobile communication system.

In accordance with an aspect of the present invention, a Java Application Descriptor (JAD) file transmission method of a transmit Mobile Station (MS) in a mobile communication system is provided. The method comprises inserting a JAD file into an Open Mobile Alliance Digital Rights Management (OMA DRM) file, and transmitting the OMA DRM file in which the JAD file is inserted, to a receive MS.

In accordance with another aspect of the present invention, a Java Application Descriptor (JAD) file reception method of a receive Mobile Station (MS) in a mobile communication system is provided. The method comprises loading a JAD file from an Open Mobile Alliance Digital Rights Management (OMA DRM) file when content of a received OMA DRM file is a Java ARchive (JAR) file, and installing the JAR file using the JAD file.

In accordance with a further another aspect of the present invention, an apparatus of a transmit Mobile Station (MS) transmitting a Java Application Descriptor (JAD) file in a mobile communication system is provided. The apparatus comprises a communication module and a controller. The communication module communicates with a different node. The controller inserts a JAD file into an Open Mobile Alliance Digital Rights Management (OMA DRM) file, and transmits the OMA DRM file in which the JAD file is inserted, to a receive MS through the communication module.

In accordance with yet another aspect of the present invention, an apparatus of a receive Mobile Station (MS) for receiving a Java Application Descriptor (JAD) file in a mobile communication system is provided. The apparatus comprises a communication module and a controller. The communication module communicates with a different node. The controller, if content of an Open Mobile Alliance Digital Rights Management (OMA DRM) file received through the communication module is a Java ARchive (JAR) file, loads a JAD file from the OMA DRM file, and installs the JAR file using the JAD file.

In accordance with still another aspect of the present invention, a method for distributing a MIDlet suite in a mobile communication system is provided. The method comprises generating a MIDlet suite as an Open Mobile Alliance Digital Rights Management (OMA DRM) file, and transmitting the OMA DRM file to a corresponding node.

In accordance with still another aspect of the present invention, a method for managing a MIDlet suite in a mobile communication system is provided. The method comprises installing a MIDlet suite according to a Mobile Information Device Profile (MIDP) standard, storing an Open Mobile Alliance Digital Rights Management (OMA DRM) file including the MIDlet suite during an installation process, and storing a database file generated during a MIDlet suite execution process as an OMA DRM file.

In accordance with still another aspect of the present invention, an apparatus for distributing a MIDlet suite in a mobile communication system is provided. The apparatus comprises a controller for generating a MIDlet suite as an Open Mobile Alliance Digital Rights Management (OMA DRM) file, and for transmitting the OMA DRM to a corresponding node.

In accordance with still another aspect of the present invention, an apparatus for managing a MIDlet suite in a mobile communication system is provided. The apparatus comprises a controller for installing a MIDlet suite according to an Mobile Information Device Profile (MIDP) standard, for storing an Open Mobile Alliance Digital Rights Management (OMA DRM) file including the MIDlet suite in an installation process, and for storing a database file generated during a MIDlet suite execution process as an OMA DRM file.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description when taken in conjunction with the accompanying drawings, in which:

FIG. 1 is a diagram illustrating a Digital Rights Management (DRM) format of an Open Mobile Alliance Digital Rights Management (OMA DRM) version 1.0 (v1.0) according to an exemplary embodiment of the present invention;

FIG. 2 is a diagram illustrating a DRM format of OMA DRM v2.0 according to an exemplary embodiment of the present invention;

FIG. 3 is a flow diagram illustrating an operation process of a transmit Mobile Station (MS) according to an exemplary embodiment of the present invention;

FIG. 4 is a flow diagram illustrating an operation process of a receive MS according to an exemplary embodiment of the present invention; and

FIG. 5 is a block diagram illustrating a construction of a transmit/receive MS according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein may be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

An apparatus and method for MIDlet suite management using Digital Rights Management (DRM) in a mobile communication system according to exemplary embodiments of the present invention are described below. As referred to herein a .JAD file and a JAD file are the same files, and a JAR file and a JAR file are same files. The dot (.) denotes an extension mark.

When installing a Java 2 Micro Edition (J2ME) application program, exemplary embodiments of the present invention construct a DCF file to be described below and store system files of the J2ME application program. The J2ME application program is distributed in .Java Application Descriptor (.JAD) and .Java ARchive (.JAR) files (or only a .JAR file), or is distributed in a DCF format including .JAD and .JAR files (or only a .JAR file).

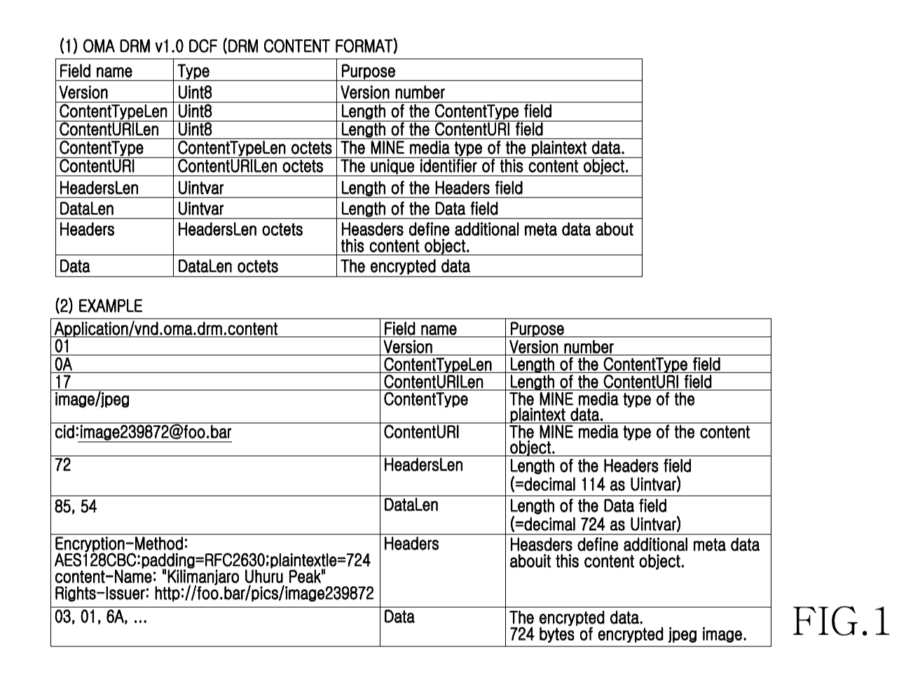

FIG. 1 is a diagram illustrating a DRM format of an Open Mobile Alliance Digital Rights Management (OMA DRM) version 1.0 (v1.0) according to an exemplary embodiment of the present invention.

Referring to FIG. 1, a DCF file of OMA DRM 1.0 including a J2ME application program is described. Files of a J2ME application program are defined by a header field such as that shown in Table 2 below and are constructed as a DCF file of OMA DRM v1.0. In order to avoid an error caused by processing of a Carriage Return Line Feed (CRLF), each value is encoded into Base64 and is stored.

TABLE 2

| Names of added | |
|---|---|
| headers | Values of added headers |
| J2ME-App-Descriptor | Value of encoding of <storage name of MIDlet |
| | suite>_suite.jad file into Base64 |
| J2ME-App-Archive | Value of encoding of <storage name of MIDlet |
| | suite>_suite.jar file into Base64 |
| J2ME-App-Manifest | Value of encoding of <storage name of MIDlet |
| | suite>_suite.mf file into Base64 |
| J2ME-App-Settings | Value of encoding of <storage name of MIDlet |
| | suite>_suite.bin file into Base64 |
| J2ME-App-JadUrl | Value of encoding of <storage name of MIDlet |
| | suite>_jadUrl.utf file into Base64 |
| J2ME-App-JarUrl | Value of encoding of <storage name of MIDlet |
| | suite>_jarUrl.utf file into Base64 |
| J2ME-App-<generated | Value of encoding of <storage name of MIDlet |
| DB name> | suite>_<DB name>.db file into Base64 |

In addition, exemplary embodiments of the present invention may add a .JAD file to a header field and include a .JAR file in a content region for transmission. At this time, exemplary embodiments of the present invention may add an arbitrary header following syntax such as that shown in Table 3 below.

TABLE 3

Other-Header := Header-name : Header-value CRLF
Header-name := token
Header-value := *TEXT

In Table 3, a header name for a .JAD file such as that shown in Table 4 below is described, and the .JAD file is encoded into BASE64 and is inserted.

TABLE 4
J2ME-APP-Descriptor : ...(.JAD file encoded into BASE64)...

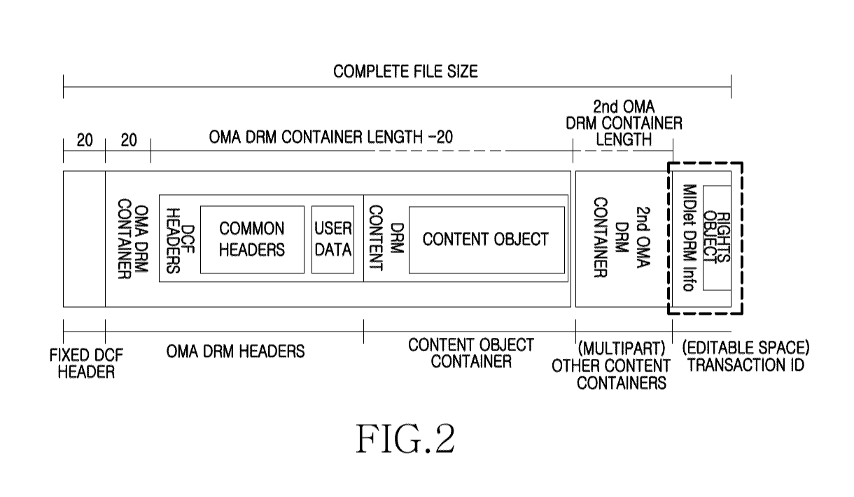

Here, the .JAD file is encoded into the BASE64 because, within the header field, CRLF is used to distinguish each header, and the .JAD file includes the CRLF. However, data encoded into BASE64 is expressed only by alphabetical characters and thus, an error is not generated. FIG. 2 is a diagram illustrating a DRM format of OMA DRM v2.0 according to an exemplary embodiment of the present invention. Referring to FIG. 2, a DCF file of OMA DRM v2.0 including a J2ME application program is described below. When a J2ME application program is installed, a DCF file of OMA DRM v2.0 including this is constructed and stored. Files of the J2ME application program are each added to a “MutableDRMInformation box”. The added boxes may be defined as shown in Table 5 below. Data of files (“JAD” to “DB”) in Table 5 below are added as shown below in a right column of a corresponding file.

TABLE 5

| Files | Added Boxes |
|---|---|
| JAD | aligned(8) class OMADRMJ2MEAppDescritor extends |
| | FullBox(‘ojad’, 0, 0) { |
| | byte Data[ ]; // JAD data |
| | } |
| JAR | aligned(8) class OMADRMJ2MEAppArchive extends |
| | FullBox(‘ojar’, 0, 0) { |
| | byte Data[ ]; // JAR data |
| | } |
| Manifest | aligned(8) class OMADRMJ2MEAppManifest extends |
| | FullBox(‘omanifest’, 0, 0) |
| | { |
| | byte Data[ ]; // Manifest data |
| | } |
| Settings.Bin | aligned(8) class OMADRMJ2MEAppSettings extends |
| | FullBox(‘osettings’, 0, 0) { |
| | byte Data[ ]; // Settings.Bin data |
| | } |
| JAD URL | aligned(8) class OMADRMJ2MEAppJadUrl extends |
| | FullBox(‘ojadurl’, 0, 0) { |
| | byte Data[ ]; // JAD URL data |
| | } |
| JAD URL | aligned(8) class OMADRMJ2MEAppJarUrl extends |
| | FullBox(‘ojarurl’, 0, 0) { |
| | byte Data[ ]; // JAD data |
| | } |
| DB | aligned(8) class OMADRMJ2MEAppDB extends |
| | FullBox(‘odb’, 0, 0) { |
| | byte Data[ ]; // JAD data |
| | } |

The data of the files (“JAD” to “DB”) shown in Table 5 above are added as shown above in the right column of the corresponding file. That is, “JAD” is stored in “aligned(8) class OMADRMJ2MEAppDescritor extends FullBox(‘ojad’, 0, 0) {}”, and “JAR” is stored in “JAR aligned(8) class OMADRMJ2MEAppArchive extends FullBox(‘ojar’, 0, 0) {}”. “Manifest” is stored in “Manifest aligned(8) class OMADRMJ2MEAppManifest extends FullBox(‘omanifest’, 0, 0) {}”, “Setting.Bin” is stored in “Settings.Bin aligned(8) class OMADRMJ2MEAppSettings extends FullBox(‘osettings’, 0, 0) {}”, “JAD URL” is stored in “JAD URL aligned(8) class OMADRMJ2MEAppJadUrl extends FullBox(‘ojadurl’, 0, 0) {}”, and “JAR URL” is stored in “JAR URL aligned(8) class OMADRMJ2MEAppJarUrl extends FullBox(‘ojarurl’, 0, 0) {}”. “DataBase (DB)” is stored in “DB aligned(8) class OMADRMJ2MEAppDB extends FullBox(‘odb’, 0, 0) {}”. Here, a region added is added to a “byte Data[]” portion.

In addition, exemplary embodiments of the present invention may add a .JAD file to a header field and include a JAR file in a content region for transmission. At this time, in the case of an OMA DRM v2.0 DRM format, exemplary embodiments of the present invention adds a .JAD file to a “Mutable DRM info” region.

Data in a box portion marked with a dotted line in FIG. 2 is described in a standard as not able to be changed. The dotted region is a “Mutable DRM Information Box” and, in a standard, is described to include “Transaction Tracking Box” and “Rights Object Box”. Thus, a box such as that shown in Table 6 below is defined for a .JAD file, and the .JAD file is added hereto.

TABLE 6

aligned(8) class OMADRMJ2MEAppDescritor extends
FullBox(‘ojad’, 0, 0) {byte Data[ ]; // JAD data
}

A J2ME application program is installed and managed in the following method. The J2ME application program stored in an apparatus is installed in an apparatus desired by a user as being specified in a Mobile Information Device Profile (MIDP) standard. When the J2ME application program is installed, it is stored in a DCF format including the aforementioned J2ME application program.

When the J2ME application program is executed, DB files generated are stored in the DCF format including the aforementioned J2ME application program. When the J2ME application program is distributed to a different apparatus, it is distributed in the DCF format including the J2ME application program, and a user or apparatus may determine to uninstall a system file of the added J2ME application program for distribution.

In the following description, exemplary embodiments of the present invention describe a case of adding a .JAD file to a header field, and including a JAR file in a content region for transmission. At this time, a content provider performs the following operation for a .JAR file to be provided.

First, the content provider generates a .JAD for a corresponding .JAR file. The .JAD file includes a Certificate and a HASH value of the .JAR file. Then, the content provider applies an OMA DRM (v1.0 Separate Delivery, or v2.0 or more) to the .JAR file. Next, the content provider distributes the .JAD file for the .JAR file and a corresponding OMA DRM file.

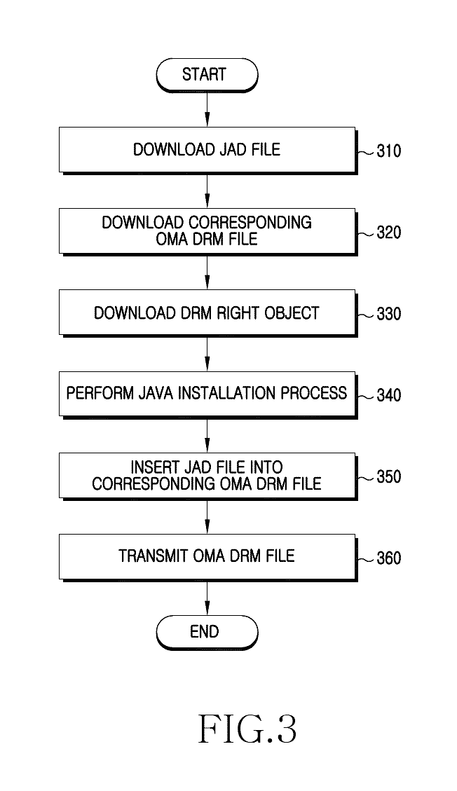

FIG. 3 is a flow diagram illustrating an operation process of a transmit Mobile Station (MS) according to an exemplary embodiment of the present invention.

Referring to FIG. 3, in step 310, the transmit MS downloads a .JAD file from a content provider. Then, in step 320, the transmit MS downloads an OMA DRM file for the .JAD file. Then, in step 330, the transmit MS downloads a right object for the OMA DRM. The right object may include key information used to access the OMA DRM file. The OMA DRM may be a .JAR file.

Then, in step 340, the transmit MS performs a JAVA installation process. The JAVA installation process is performed according to an MIDP standard. However, a JAVA Application Management Software (AMS) performs a process of decoding an encoded .JAR file, determining a HASH value, and performing a comparison with a HASH value within a .JAD file.

Then, in step 350, the transmit MS inserts the .JAD file into the OMA DRM file. Here, as aforementioned, in the case of OMA DRM v1.0, the .JAD file is added to a header field and, in the case of OMA DRM v2.0, is added to a “Mutable DRM Information Box”.

Then, in step 360, the transmit MS transmits the OMA DRM file to which the .JAD file is added, to a different MS using a Multimedia Message Service (MMS), an electronic mail (E-mail), a Bluetooth, or an F-flash.

Then, the transmit MS terminates the process according to the present invention.

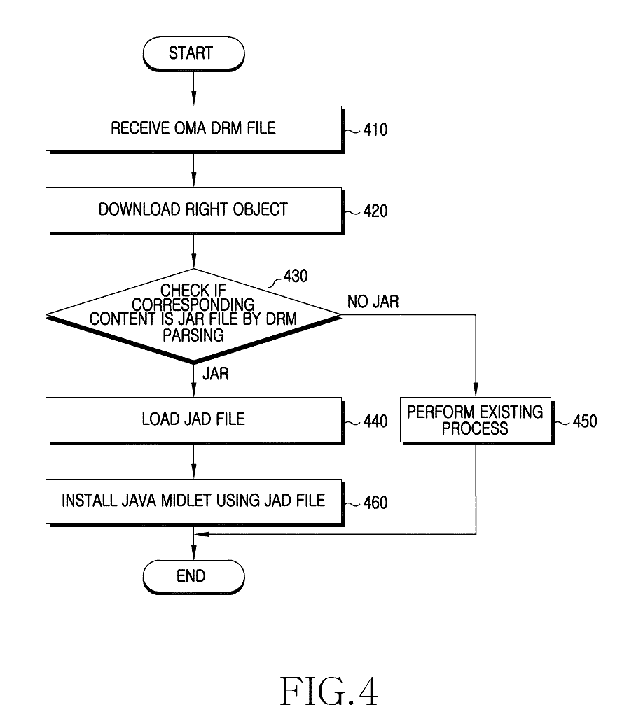

FIG. 4 is a flow diagram illustrating an operation process of a receive MS according to an exemplary embodiment of the present invention.

Referring to FIG. 4, in step 410, the receive MS receives an OMA DRM file transmitted by a transmit MS. Then, in step 420, the receive MS downloads a right object for the OMA DRM file. The right object may include key information used to access the OMA DRM file.

Then, in step 430, the receive MS determines if content is a .JAR file by parsing for the OMA DRM file. This process may include a process of determining if a .JAD file is included in the OMA DRM file.

If the content is not the .JAR file, in step 450, the receive MS performs an existing process.

If the content is the .JAR file, as aforementioned, in step 440, the receive MS acquires a .JAD file from a header field in the case of OMA DRM v1.0 and from a “Mutable DRM Information Box” in the case of OMA DRM v2.0, and loads the .JAD file. Then, in step 460, the receive MS installs a corresponding JAVA MIDlet using the .JAD file.

Then, the receive MS terminates the process according to an exemplary embodiment of the present invention.

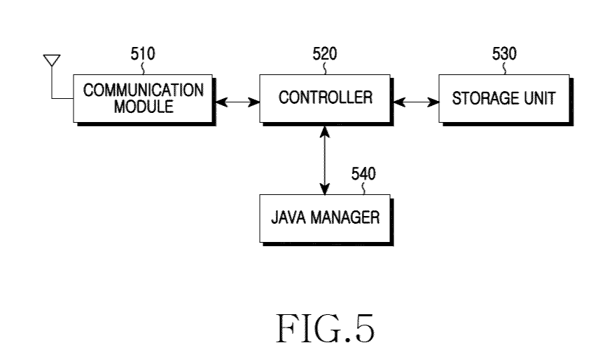

FIG. 5 is a block diagram illustrating a construction of a transmit/receive MS according to an exemplary embodiment of the present invention.

The transmit/receive MS includes a communication module 510, a controller 520, a storage unit 530, and a JAVA manager 540.

The communication module 510 is a module for communicating with a different node, and includes a wireless processor, a baseband processor, etc. The wireless processor converts a signal received through an antenna into a baseband signal and provides the baseband signal to the baseband processor, and converts a baseband signal from the baseband processor into a Radio Frequency (RF) signal and transmits the RF signal through the antenna.

The controller 520 controls general operations of the MS. More particularly, the controller 520 controls the JAVA manager 540 according to an exemplary embodiment of the present invention.

The storage unit 530 performs a function of storing one or more programs for controlling general operations of the transmit/receive MS and temporary data generated during execution of the one or more programs.

If the MS is a transmit MS, the JAVA manager 540 downloads a .JAD file, an OMA DRM file for the .JAD file, and a right object for the OMA DRM. Then, the JAVA manager 540 performs a JAVA installation process. The JAVA installation process is performed according to a MIDP standard. Next, the JAVA manager 540 inserts the .JAD file into the OMA DRM file. Here, as aforementioned, the .JAD file is added to a header field in the case of OMA DRM v1.0, and is added to a “Mutable DRM Information Box” in the case of OMA DRM v2.0. The JAVA manager 540 transmits the OMA DRM file to a receive MS using one of an MMS, an E-mail, a Bluetooth, and an F-flash.

If the MS is a receive MS, the JAVA manager 540 receives an OMA DRM file transmitted by the transmit MS. The JAVA manager 540 downloads a right object for the OMA DRM file. Then, the JAVA manager 540 determines if content is a .JAR file by parsing for the OMA DRM file. If the content is the .JAR file, the JAVA manager 540 performs a general process. If the content is the .JAR file, as aforementioned, the JAVA manager 540 loads a .JAD file from a header field in the case of OMA DRM v1.0, and from “Mutable DRM Information Box” in the case of OMA DRM v2.0. Then, the JAVA manager 540 installs a corresponding JAVA MIDlet using the .JAD file.

In the aforementioned block construction, the controller 520 may perform a function of the JAVA manager 540. These are separately constructed and illustrated in order to distinguish and describe respective functions in an exemplary embodiment of the present invention.

However, in an actual implantation, the transmit/receive MS may be constructed such that all functions of the JAVA manager 540 are processed in the controller 520, and may be constructed such that only part of the functions are processed in the controller 520.

If the MS is an apparatus installing the J2ME application program (i.e., the MIDlet suite) or an apparatus managing, as aforementioned, when installing a stored J2ME application program, the JAVA manager 540 then stores files to be installed, in a DCF format including the J2ME application program. When executing the J2ME application program, as aforementioned, the JAVA manager 540 stores generated DB files in the DCF format including the J2ME application program. The storage unit 530 stores the J2ME application programs of the DCF format (i.e., the OMA DRM files).

Exemplary embodiments of the present invention protect files of a MIDlet suite from a malicious loss or damage while enabling execution in various apparatuses (i.e., a mobile communication terminal, an external memory, etc.). Exemplary embodiments of the present invention have an advantage of enabling safe management because files of a MIDlet suite are protected by DRM, even upon transmission to a different apparatus that is capable of protecting MIDlet suites.

Exemplary embodiments of the present invention enable a user to maintain information generated in a J2ME application program while it is used in several apparatuses. In addition, exemplary embodiments of the present invention prevent a user from decompiling a class code within a .JAR file while enabling distribution of a J2ME application program. Exemplary embodiments of the present invention have an advantage of being capable of using their own billing system for DRM without having to implement a purchase system of a J2ME application program for demonstration.

Exemplary embodiments the present invention have an advantage of being capable of easily sharing a JAVA game or application program with a different user, and using a forwarding function with increased convenience. Exemplary embodiments of the present invention have an advantage that a content provider may spread a corresponding JAVA game or application program to more users. In addition, exemplary embodiments of the present invention have an advantage of including a .JAD file in an OMA DRM file for transmission, and being capable of transmitting all contents with only OMA DRM file transmission.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A Java Application Descriptor (JAD) file transmission method of a transmit Mobile Station (MS) in a mobile communication system, the method comprising:
inserting a JAD file into an Open Mobile Alliance Digital Rights Management (OMA DRM) file; and
transmitting the OMA DRM file in which the JAD file is inserted, to a receive MS.

2. The method of claim 1, wherein the inserting of the JAD file into the OMA DRM file comprises inserting the JAD file into a header field if the OMA DRM file is an OMA DRM version 1.0 (v1.0) file.

3. The method of claim 1, wherein the inserting of the JAD file into the OMA DRM file comprises inserting the JAD file into a “Mutable DRM Information Box” field if the OMA DRM file is an OMA DRM version 2.0 (v2.0) file.

4. The method of claim 1, wherein content of the OMA DRM file is a Java ARchive (JAR) file for the JAD file.

5. A Java Application Descriptor (JAD) file reception method of a receive Mobile Station (MS) in a mobile communication system, the method comprising:
loading a JAD file from an Open Mobile Alliance Digital Rights Management (OMA DRM) file when content of a received OMA DRM file is a Java ARchive (JAR) file; and
installing the JAR file using the JAD file.

6. The method of claim 5, wherein the loading of the JAD file from the OMA DRM file comprises loading the JAD file from a header field if the OMA DRM file is an OMA DRM version 1.0 (v1.0) file.

7. The method of claim 5, wherein the loading of the JAD file from the OMA DRM file comprises loading the JAD file from a “Mutable DRM Information Box” field if the OMA DRM file is an OMA DRM version 2.0 (v2.0) file.

8. An apparatus of a transmit Mobile Station (MS) transmitting a Java Application Descriptor (JAD) file in a mobile communication system, the apparatus comprising:
a communication module for communicating with a different node; and
a controller for inserting a JAD file into an Open Mobile Alliance Digital Rights Management (OMA DRM) file, and for transmitting the OMA DRM file in which the JAD file is inserted, to a receive MS through the communication module.

9. The apparatus of claim 8, wherein, if the OMA DRM file is an OMA DRM version 1.0 (v1.0) file, the controller inserts the JAD file into a header field.

10. The apparatus of claim 8, wherein, if the OMA DRM file is an OMA DRM version 2.0 (v2.0) file, the controller inserts the JAD file into a “Mutable DRM Information Box” field.

11. The apparatus of claim 8, wherein content of the OMA DRM file is a JAR file for the JAD file.

12. An apparatus for a receive Mobile Station (MS) for receiving a Java Application Descriptor (JAD) file in a mobile communication system, the apparatus comprising:
a communication module for communicating with a different node; and
a controller for, if content of an Open Mobile Alliance Digital Rights Management (OMA DRM) file received through the communication module is a Java ARchive (JAR) file, loading a JAD file from the OMA DRM file, and for installing the JAR file using the JAD file.

13. The apparatus of claim 12, wherein, if the OMA DRM file is an OMA DRM version 1.0 (v1.0) file, the controller loads the JAD file from a header field.

14. The apparatus of claim 12, wherein, if the OMA DRM file is an OMA DRM version 2.0 (v2.0) file, the controller loads the JAD file from a “Mutable DRM Information Box” field.

15. A method for distributing a MIDlet suite in a mobile communication system, the method comprising:
generating a MIDlet suite as an Open Mobile Alliance Digital Rights Management (OMA DRM) file; and
transmitting the OMA DRM file to a corresponding node.

16. The method of claim 15, wherein, the generating of the MIDlet suite as the OMA DRM file comprises, if the OMA DRM file is an OMA DRM version 1.0 (v1.0) file, generating the MIDlet suite as the OMA DRM file by defining files of a MIDlet suite by a header field as in the table:

| Names of added | |
|---|---|
| headers | Values of added headers |
| J2ME-App- | Value of encoding of <storage name of MIDlet |
| Descriptor | suite>_suite.jad file into Base64 |
| J2ME-App-Archive | Value of encoding of <storage name of MIDlet |
| | suite>_suite.jar file into Base64 |
| J2ME-App-Manifest | Value of encoding of <storage name of MIDlet |
| | suite>_suite.mf file into Base64 |
| J2ME-App-Settings | Value of encoding of <storage name of MIDlet |
| | suite>_suite.bin file into Base64 |
| J2ME-App-JadUrl | Value of encoding of <storage name of MIDlet |
| | suite>_jadUrl.utf file into Base64 |
| J2ME-App-JarUrl | Value of encoding of <storage name of MIDlet |
| | suite>_jarUrl.utf file into Base64 |
| J2ME-App- | Value of encoding of <storage name of MIDlet |
| <generated DB | suite>_<DB name>.db file into Base64 |
| name> | |

17. The method of claim 15, wherein, the generating of the MIDlet suite as the OMA DRM file comprises, if the OMA DRM file is an OMA DRM version 2.0 (v2.0) file, generating the MIDlet suite as the OMA DRM file by adding files of a MIDlet suite to a “MutableDRMInformation box” as in the table:

| Files | Added Boxes |
|---|---|
| JAD | aligned(8) class OMADRMJ2MEAppDescritor extends |
| | FullBox(‘ojad’, 0, 0) { |
| | byte Data[ ]; // JAD data |
| | } |
| JAR | aligned(8) class OMADRMJ2MEAppArchive extends |
| | FullBox(‘ojar’, 0, 0) { |
| | byte Data[ ]; // JAR data |
| | } |
| Manifest | aligned(8) class OMADRMJ2MEAppManifest extends |
| | FullBox(‘omanifest’, 0, 0) |
| | { |
| | byte Data[ ]; // Manifest data |
| | } |
| Settings.Bin | aligned(8) class OMADRMJ2MEAppSettings extends |
| | FullBox(‘osettings’, 0, 0) { |
| | byte Data[ ]; // Settings.Bin data |
| | } |
| JAD URL | aligned(8) class OMADRMJ2MEAppJadUrl extends |
| | FullBox(‘ojadurl’, 0, 0) { |
| | byte Data[ ]; // JAD URL data |
| | } |
| JAR URL | aligned(8) class OMADRMJ2MEAppJarUrl extends |
| | FullBox(‘ojarurl’, 0, 0) { |
| | byte Data[ ]; // JAD data |
| | } |
| DB | aligned(8) class OMADRMJ2MEAppDB extends |
| | FullBox(‘odb’, 0, 0) { |
| | byte Data[ ]; // JAD data |
| | } |

18. A method for managing a MIDlet suite in a mobile communication system, the method comprising:
installing a MIDlet suite according to a Mobile Information Device Profile (MIDP) standard;
storing an Open Mobile Alliance Digital Rights Management (OMA DRM) file comprising the MIDlet suite during an installation process; and
storing a database file generated during a MIDlet suite execution process as an OMA DRM file.

19. The method of claim 18, wherein the storing of the OMA DRM file comprising the MIDlet suite and the storing of the database file as the OMA DRM file comprises, if the OMA DRM file is an OMA DRM version 1.0 (v1.0) file, defining files of a MIDlet suite by a header field as in the table:

| Names of added | |
|---|---|
| headers | Values of added headers |
| J2ME-App- | Value of encoding of <storage name of MIDlet |
| Descriptor | suite>_suite.jad file into Base64 |
| J2ME-App-Archive | Value of encoding of <storage name of MIDlet |
| | suite>_suite.jar file into Base64 |
| J2ME-App-Manifest | Value of encoding of <storage name of MIDlet |
| | suite>_suite.mf file into Base64 |
| J2ME-App-Settings | Value of encoding of <storage name of MIDlet |
| | suite>_suite.bin file into Base64 |
| J2ME-App-JadUrl | Value of encoding of <storage name of MIDlet |
| | suite>_jadUrl.utf file into Base64 |
| J2ME-App-JarUrl | Value of encoding of <storage name of MIDlet |
| | suite>_jarUrl.utf file into Base64 |
| J2ME-App- | Value of encoding of <storage name of MIDlet |
| <generated DB | suite>_<DB name>.db file into Base64 |
| name> | |

20. The method of claim 18, wherein the storing of the OMA DRM file comprising the MIDlet suite and the storing of the database file as the OMA DRM file comprises, if the OMA DRM file is an OMA DRM version 2.0 (v2.0) file, adding files of a MIDlet suite to a “MutableDRMInformation box” as in the table:

| Files | Added Boxes |
|---|---|
| JAD | aligned(8) class OMADRMJ2MEAppDescritor extends |
| | FullBox(‘ojad’, 0, 0) { |
| | byte Data[ ]; // JAD data |
| | } |
| JAR | aligned(8) class OMADRMJ2MEAppArchive extends |
| | FullBox(‘ojar’, 0, 0) { |
| | byte Data[ ]; // JAR data |
| | } |
| Manifest | aligned(8) class OMADRMJ2MEAppManifest extends |
| | FullBox(‘omanifest’, 0, 0) |
| | { |
| | byte Data[ ]; // Manifest data |
| | } |
| Settings.Bin | aligned(8) class OMADRMJ2MEAppSettings extends |
| | FullBox(‘osettings’, 0, 0) { |
| | byte Data[ ]; // Settings.Bin data |
| | } |
| JAD URL | aligned(8) class OMADRMJ2MEAppJadUrl extends |
| | FullBox(‘ojadurl’, 0, 0) { |
| | byte Data[ ]; // JAD URL data |
| | } |
| JAR URL | aligned(8) class OMADRMJ2MEAppJarUrl extends |
| | FullBox(‘ojarurl’, 0, 0) { |
| | byte Data[ ]; // JAD data |
| | } |
| DB | aligned(8) class OMADRMJ2MEAppDB extends |
| | FullBox(‘odb’, 0, 0) { |
| | byte Data[ ]; // JAD data |
| | } |

21. An apparatus for distributing a MIDlet suite in a mobile communication system, the apparatus comprising:
a controller for generating a MIDlet suite as an Open Mobile Alliance Digital Rights Management (OMA DRM) file, and for transmitting the OMA DRM to a corresponding node.

22. The apparatus of claim 21, wherein, if the OMA DRM file is an OMA DRM version 1.0 (v1.0) file, the controller defines files of a MIDlet suite by a header field as in the table:

| Names of added | |
|---|---|
| headers | Values of added headers |
| J2ME-App- | Value of encoding of <storage name of MIDlet |
| Descriptor | suite>_suite.jad file into Base64 |
| J2ME-App-Archive | Value of encoding of <storage name of MIDlet |
| | suite>_suite.jar file into Base64 |
| J2ME-App-Manifest | Value of encoding of <storage name of MIDlet |
| | suite>_suite.mf file into Base64 |
| J2ME-App-Settings | Value of encoding of <storage name of MIDlet |
| | suite>_suite.bin file into Base64 |
| J2ME-App-JadUrl | Value of encoding of <storage name of MIDlet |
| | suite>_jadUrl.utf file into Base64 |
| J2ME-App-JarUrl | Value of encoding of <storage name of MIDlet |
| | suite>_jarUrl.utf file into Base64 |
| J2ME-App- | Value of encoding of <storage name of MIDlet |
| <generated DB | suite>_<DB name>.db file into Base64 |
| name> | |

23. The apparatus of claim 21, wherein, if the OMA DRM file is an OMA DRM version 2.0 (v2.0) file, the controller adds files of a MIDlet suite to a “MutableDRMInformtion box” as in the table:

| Files | Added Boxes |
|---|---|
| JAD | aligned(8) class OMADRMJ2MEAppDescritor extends |
| | FullBox(‘ojad’, 0, 0) { |
| | byte Data[ ]; // JAD data |
| | } |
| JAR | aligned(8) class OMADRMJ2MEAppArchive extends |
| | FullBox(‘ojar’, 0, 0) { |
| | byte Data[ ]; // JAR data |
| | } |
| Manifest | aligned(8) class OMADRMJ2MEAppManifest extends |
| | FullBox(‘omanifest’, 0, 0) |
| | { |
| | byte Data[ ]; // Manifest data |
| | } |
| Settings.Bin | aligned(8) class OMADRMJ2MEAppSettings extends |
| | FullBox(‘osettings’, 0, 0) { |
| | byte Data[ ]; // Settings.Bin data |
| | } |
| JAD URL | aligned(8) class OMADRMJ2MEAppJadUrl extends |
| | FullBox(‘ojadurl’, 0, 0) { |
| | byte Data[ ]; // JAD URL data |
| | } |
| JAR URL | aligned(8) class OMADRMJ2MEAppJarUrl extends |
| | FullBox(‘ojarurl’, 0, 0) { |
| | byte Data[ ]; // JAD data |
| | } |
| DB | aligned(8) class OMADRMJ2MEAppDB extends |
| | FullBox(‘odb’, 0, 0) { |
| | byte Data[ ]; // JAD data |
| | } |

24. An apparatus for managing a MIDlet suite in a mobile communication system, the apparatus comprising:
a controller for installing a MIDlet suite according to a Mobile Information Device Profile (MIDP) standard, for storing an Open Mobile Alliance Digital Rights Management (OMA DRM) file comprising the MIDlet suite in an installation process, and for storing a database file generated during a MIDlet suite execution process as an OMA DRM file.

25. The apparatus of claim 24, wherein, if the OMA DRM file is an OMA DRM version 1.0 (v1.0) file, the controller defines files of a MIDlet suite by a header field as in the table:

| Names of added | |
|---|---|
| headers | Values of added headers |
| J2ME-App- | Value of encoding of <storage name of MIDlet |
| Descriptor | suite>_suite.jad file into Base64 |
| J2ME-App-Archive | Value of encoding of <storage name of MIDlet |
| | suite>_suite.jar file into Base64 |
| J2ME-App-Manifest | Value of encoding of <storage name of MIDlet |
| | suite>_suite.mf file into Base64 |
| J2ME-App-Settings | Value of encoding of <storage name of MIDlet |
| | suite>_suite.bin file into Base64 |
| J2ME-App-JadUrl | Value of encoding of <storage name of MIDlet |
| | suite>_jadUrl.utf file into Base64 |
| J2ME-App-JarUrl | Value of encoding of <storage name of MIDlet |
| | suite>_jarUrl.utf file into Base64 |
| J2ME-App- | Value of encoding of <storage name of MIDlet |
| <generated DB | suite>_<DB name>.db file into Base64 |
| name> | |

26. The apparatus of claim 24, wherein, if the OMA DRM file is an OMA DRM version 2.0 (v2.0) file, the controller adds files of a MIDlet suite to a “MutableDRMInformtion box” as in the table:

| Files | Added Boxes |
|---|---|
| JAD | aligned(8) class OMADRMJ2MEAppDescritor extends |
| | FullBox(‘ojad’, 0, 0) { |
| | byte Data[ ]; // JAD data |
| | } |
| JAR | aligned(8) class OMADRMJ2MEAppArchive extends |
| | FullBox(‘ojar’, 0, 0) { |
| | byte Data[ ]; // JAR data |
| | } |
| Manifest | aligned(8) class OMADRMJ2MEAppManifest extends |
| | FullBox(‘omanifest’, 0, 0) |
| | { |
| | byte Data[ ]; // Manifest data |
| | } |
| Settings Bin | aligned(8) class OMADRMJ2MEAppSettings extends |
| | FullBox(‘osettings’, 0, 0) { |
| | byte Data[ ]; // Settings.Bin data |
| | } |
| JAD URL | aligned(8) class OMADRMJ2MEAppJadUrl extends |
| | FullBox(‘ojadurl’, 0, 0) { |
| | byte Data[ ]; // JAD URL data |
| | } |
| JAR URL | aligned(8) class OMADRMJ2MEAppJarUrl extends |
| | FullBox(‘ojarurl’, 0, 0) { |
| | byte Data[ ]; // JAD data |
| | } |
| DB | aligned(8) class OMADRMJ2MEAppDB extends |
| | FullBox(‘odb’, 0, 0) { |
| | byte Data[ ]; // JAD data |
| | } |
